(19) United States
(12) Patent Application Publication
(10) Pub. No.: US 2004/0024336 A1
(43) Pub. Date: Feb. 5, 2004

(54) Massaging patting bar

(76) Inventor: Jui-Hsing Lin, Chia-Yi City (TW)

Correspondence Address: BRUCE H. TROXELL, SUITE 1404, 5205 LEESBURG PIKE, FALLS CHURCH, VA, 22041, US

(21) Appl. No.: 10/209,863

(22) Filed: Aug. 2, 2002

(51) Int. Cl. A61H 23/06; A61H 15/00

(52) U.S. Cl. 601/107; 601/120; 601/135

(57) ABSTRACT

Massaging patting bar including a massaging roller and a grip body. The massaging roller via a pin member is rotatably connected with one end of the grip body. The other end of the grip body is connected with a massaging ball bottle or a patting member. The circumference of the roller is formed with multiple massaging thorns or tenons which are spirally arranged about the axis of the roller. When the roller is pressed against a massaged part and rotated back and forth, the massaging thorns or tenons evenly press and massage the massaged part. The massaging ball bottle and the patting member provide various massaging effects.

### BACKGROUND OF THE INVENTION

The present invention is related to a massaging patting bar including a massaging roller and a grip body. The circumference of the roller is formed with multiple massaging thorns or tenons which are spirally arranged about the axis of the roller. When the roller is pressed against a massaged part and rotated back and forth, the massaging thorns or tenons evenly provide a better massaging effect. The massaging bar can be used in cooperation with a massaging ball bottle or a patting member to provide various massaging effects.

The conventional massaging bars can be substantially divided into two types, that is, patting type and pressing type. With respect to the patting type massaging bar, Taiwanese Patent Publication No. 190706 “blood energizing healthy patting device” discloses a patting device including a handle and a bundle of patting strips collectively disposed at one end of the handle. The patting strips are made of metallic, wooden or plastic material or the like. A user can pat certain vital points or uncomfortable parts of his/her body with the patting strips to free the vessels and eliminate tiredness or pain.

According to the above patting device, after the patting strips are bundled, the ends of the patting strips are tied or sheathed and bound with the handle.

According to the above structure, only the outward patting strips are rigidly bound, while the inward patting strips are not truly bound. Therefore, after a period of use, the inward patting strips are easy to loosen and detach in patting.

With respect to the pressing type massaging bar, a massaging roller is rotatably connected with one end of the handle via an insertion pin. The surface of the massaging roller is formed with multiple annularly arranged thorny protuberances. When the roller is pressed against a user's skin or vital point and rotated back and forth, the thorny protuberances press and massage the skin or vital point to enhance blood circulation and eliminate tiredness and pain. The protuberances of such massaging bar are annularly arranged at equal intervals along the same circumference. Therefore, when rolled back and forth, the adjacent protuberances only stimulate the portions along the same circumference, while failing to more densely touch the user's skin or vital point. That is, the massaged positions are spaced by a considerably long distance so that the massaging bar fails to provide an even massaging effect.

On the other hand, the conventional massaging oil or grease is viscous and generally contained in a hard bottle. When used, a user needs to dig the oil or grease with a hand or with a ladle and then paint the oil or grease onto the body and rub the body so as to achieve a massaging effect. According to the above, after the user's hand is dipped in the oil or grease, the user's hand can hardly firmly hold other article such as the massaging bar. Therefore, it is necessary to repeatedly wash or clean the hand with a piece of cloth. This is quite troublesome and inconvenient. A painting bottle specifically for containing therein a lubricant oil has been developed. A rolling ball member is inlaid in the opening of the bottle. When a user reverses the bottle and presses the ball member against his/her skin and rolls the ball member thereon, the fluid contained in the bottle attaching to the ball member will be painted onto the user's skin. Therefore, the fluid can be painted onto the body without attaching to the user's hand. However, such bottle can only paint liquid oil onto the skin. With respect to the thicker grease, the grease cannot flow to the opening and attach to the ball member so that such bottle cannot paint the grease onto the user's body. Therefore, it is necessary to provide a painting bottle capable to containing and painting both oil and grease.

The above massaging devices are independently used. In the case that they are combined for providing various massaging effects, the massaging device may have too large volume and cannot be conveniently carried. This problem should be solved.

### SUMMARY OF THE INVENTION

It is therefore a primary object of the present invention to provide a patting bar composed of a bundle of patting strips and a binding body. The patting strips are slender straight strips. One end of the binding body is compressed into a binding section. The other end of the binding body has an original inner diameter and is connected with a grip section. The ends of the bundled patting strips are inserted and bound in the binding section. After the ends of the patting strips are inserted through the binding section, the binding section is inward compressed into smaller diameter to tightly bind the patting strips. The ends of the patting strips positioned in the other end of the binding body are loosened and diverged. Therefore, the ends of the patting strips will not abut against the binding body and the patting strips are prevented from loosening and detaching from the binding body.

It is a further object of the present invention to provide a massaging bar including a massaging roller and a grip body. The massaging roller is rotatably connected with one end of the grip body. The circumference of the roller is formed with multiple massaging thorns or tenons which are spirally arranged about the axis of the roller, whereby when the roller is pressed against a contact face and rotated back and forth, the massaging thorns or tenons evenly press and massage the massaged part to achieve better massaging effect.

It is still a further object of the present invention to provide a grease painting bottle in which a driving unit is disposed for pushing a movable tray. A ball member is inlaid in the opening of the bottle. A thick grease can be filled between the movable tray and the ball member. The driving unit can drive the movable tray to push a certain amount of grease to attach to the inner face of the ball member. When the ball member is rotated, the grease attaching to inner face of the ball member is moved out and painted on the surface of a user's skin. The ball member rubs the skin to achieve double massaging effects.

It is still a further object of the present invention to provide the above grease painting bottle in which the ball member is a metal ball and a magnet is disposed between the driving unit and the ball member. The ball member is magnetized by the magnet, whereby when contacting with human skin, the ball member can stimulate the skin by way of magnetic field.

It is still a further object of the present invention to provide the above patting bar in which a grip section is connected with the inner end of the binding body for a user to hold. Alternatively, another type of massaging member can be connected with the inner end of the patting bar to achieve various massaging effects.

It is still a further object of the present invention to provide the above massaging bar in which a connecting member having outer threads at two ends can be screwed with the outer end of the sheath body. When a user selects one pattern of massaging roller for massaging, the detached sheath body can be serially connected with the end section of another sheath body via the connecting section. Therefore, the total length of the massaging bar is elongated for a user to conveniently massage a distal part of his/her body such as the back.

The present invention can be best understood through the following description and accompanying drawings wherein:

### BRIEF DESCRIPTION OF THE DRAWINGS

FIG. 1 is a perspective assembled view of the present invention;

FIG. 2 is a plane assembled view of the present invention;

FIG. 3 is a perspective assembled view of another embodiment of the present invention;

FIG. 4 is a perspective partially sectional view of the bottle body of the present invention;

FIG. 5 is a sectional view showing the operation of the ball body of the present invention;

FIG. 5A is a sectional view taken along line A-A of FIG. 5;

FIG. 6 shows another embodiment of the present invention; and

FIG. 7 is a sectional view of a part of the patting unit of the present invention.

### DETAILED DESCRIPTION OF THE PREFERRED EMBODIMENTS

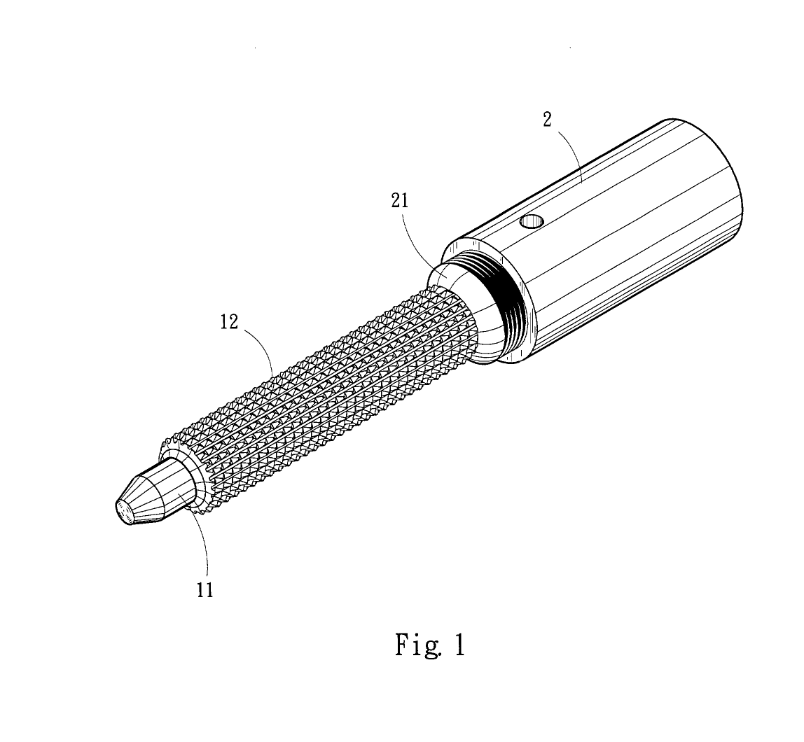

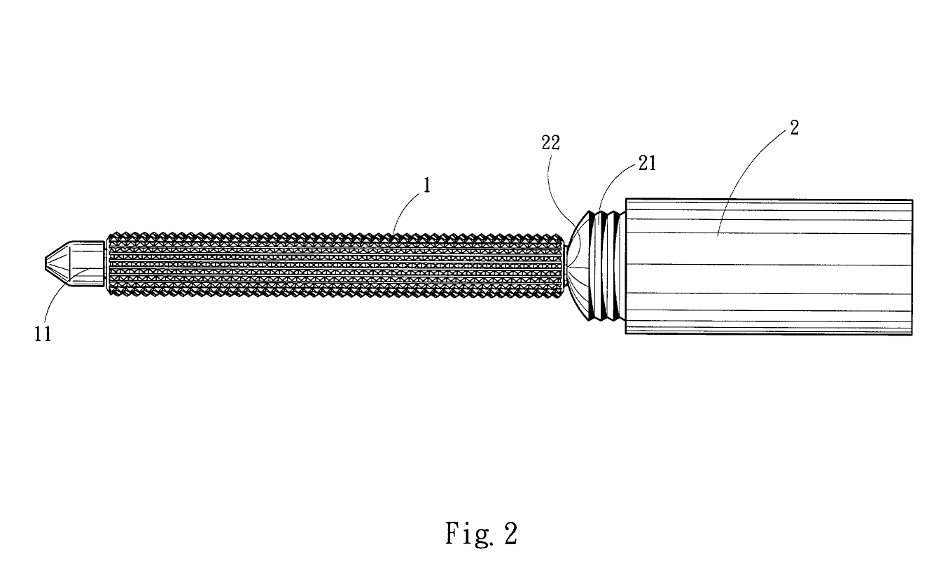

Please refer to FIGS. 1 and 2. The present invention includes a massaging roller 1 and a tubular grip body 2. The massaging roller 1 is a cylindrical body. A pin member 11 is passed through the roller 1, whereby the roller 1 is freely rotatably connected with an end section of the grip body 2. The circumference of the roller 1 is formed with multiple massaging protuberances (thorns or tenons) 12 which are spirally arranged about the axis of the roller 1. The spiral is inclined from the horizontal face, whereby when the roller 1 is rotated, the massaging protuberances 12 evenly touch and press a contact face of a user so as to achieve massaging effect.

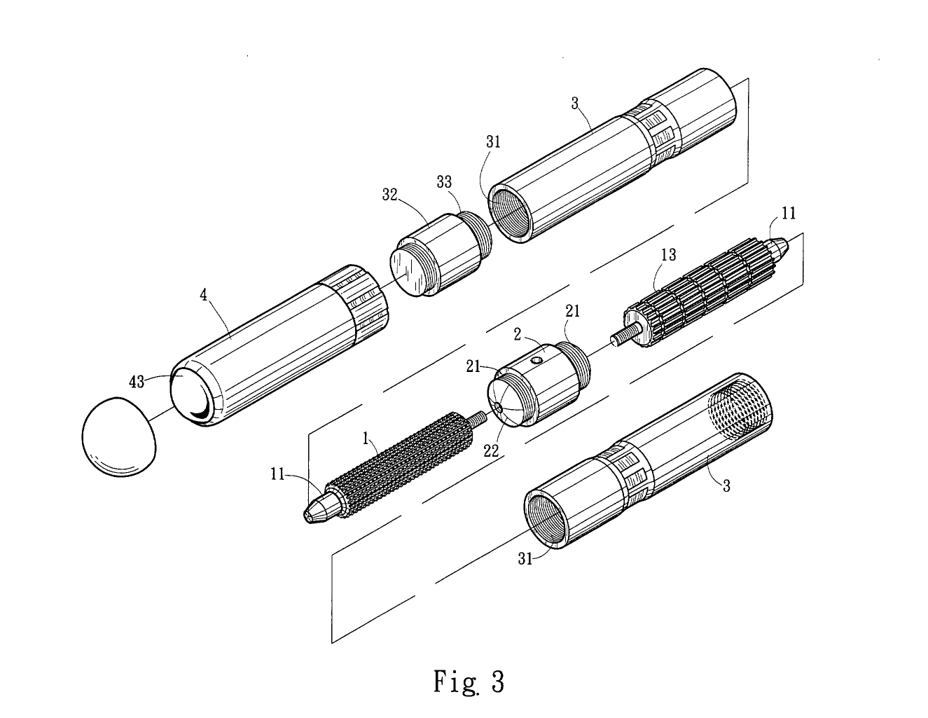

Referring to FIG. 3, another massaging roller 13 with another aspect of thorns or tenons 12 is pivotally connected with the other end of the grip body 2. Two ends of the grip body 2 are formed with outer threads 21 for screwing with sheath bodies 3 for covering and shielding the massaging rollers 1, 13. In addition, the centers of the end sections of the grip body 2 are formed with thread holes 22 for rotatably connecting with the massaging rollers 1, 13. One end of each sheath body 3 is formed with inner thread 31 corresponding to the outer thread 21 of the grip body 2 for screwing with the grip body 2. The other end of the sheath body 3 can be a close end or an open end formed with inner thread. Accordingly, the massaging bar has two different patterns of massaging protuberances to selectively provide different massaging effects for a user. The sheath bodies 3 serve to serially connect with the massaging bar to shield the same for easy carriage. Moreover, the sheath bodies 3 serve to adjust the volume and length of the massaging bar for convenient use.

A connecting member 32 having outer threads 33 at two ends can be screwed with the outer end of the sheath body 3. When a user selects one pattern of massaging roller for massaging, the detached sheath body 3 can be serially screwed with the connecting member 32 screwed with the end section of the other sheath body 2. Therefore, the total length of the massaging bar is elongated for a user to conveniently massage a distal part of his/her body such as the back.

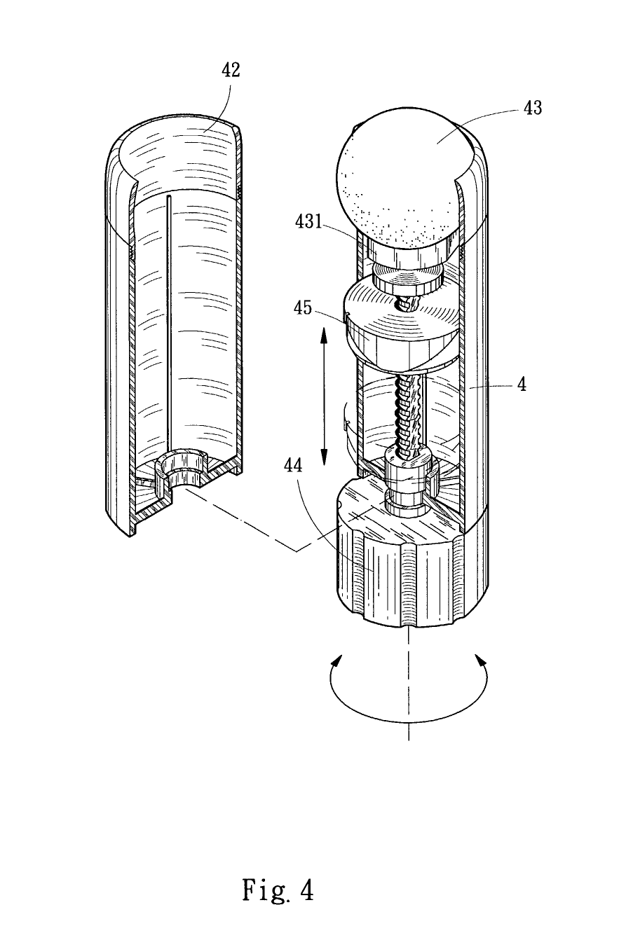

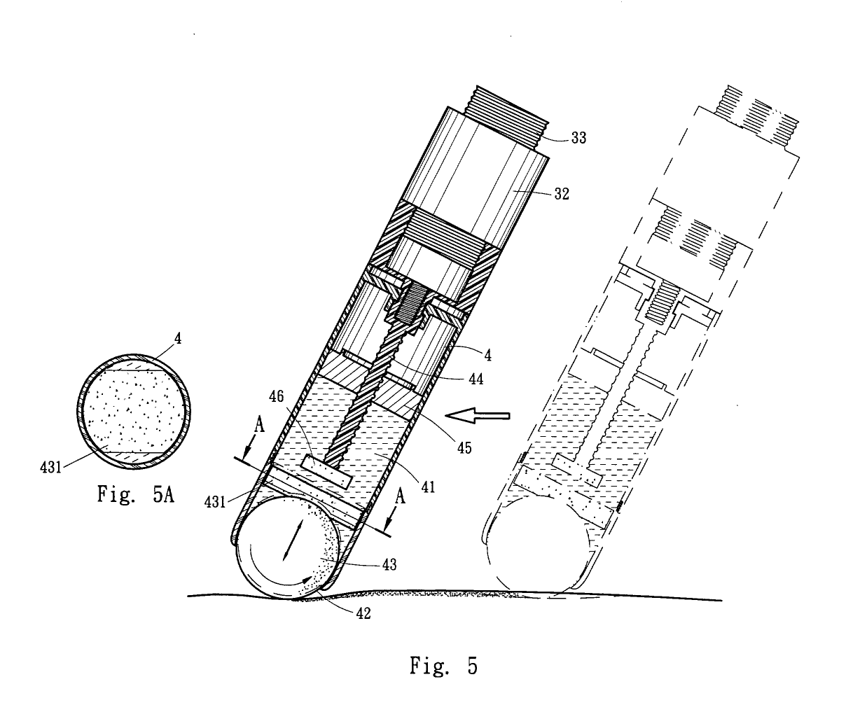

Referring to FIGS. 4 and 5, a bottle body 4 can be serially connected with one end of the connecting member 32. The bottle body 4 contains therein a certain amount of oil or grease 41. A ball body 43 is inlaid in an opening 42 of the bottle body 4. A magnet 431 magnetically attracts an inner bottom end of the ball body 43. A driving unit 44 is disposed in the bottle body 4 and drivable by external force. The driving unit 44 serves to drive a tray body 45 for pushing the oil or grease 41 to attach to the ball body 43. When the ball body 43 is rotated, a certain amount of oil or grease 41 attaching to inner side of the ball body 43 is moved out and painted on the surface of a user's skin for relieving the massaged part from uncomfortableness. A magnet push member 46 is fixedly connected with inner end of the driving unit 44 between the inner end and the magnet 431. The magnet push member 46 has a polarity identical to that of the magnet 431 for repelling the magnet 431 outward. In the case that the ball body 43 is also polar, when pressed and rolled, the ball body 43 exerts an inward tender magnetic buoyant force to enhance the massaging effect by means of the magnetic field.

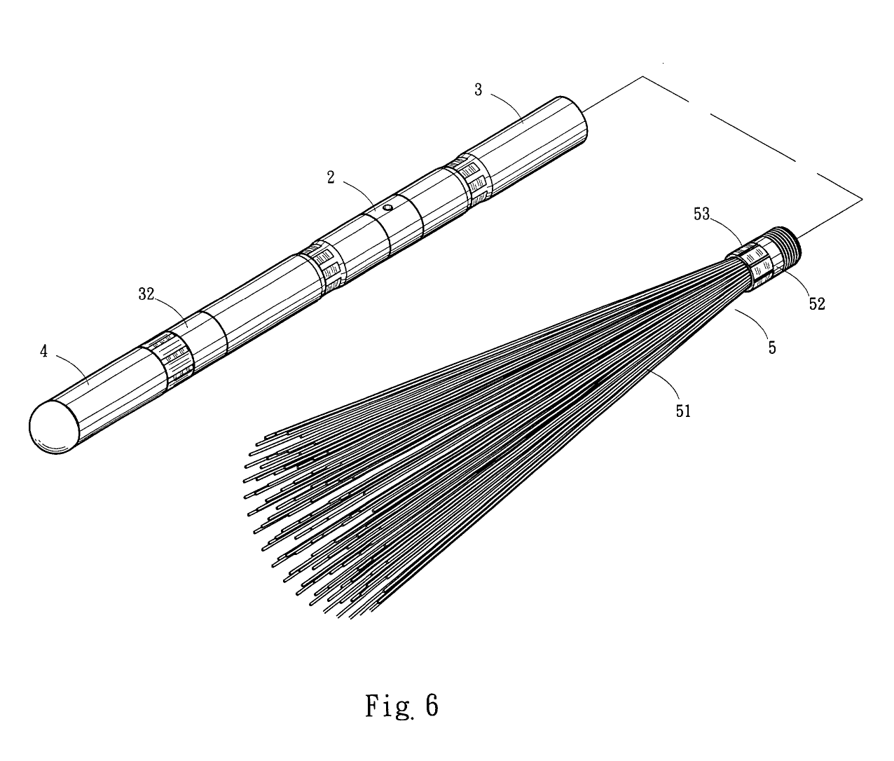

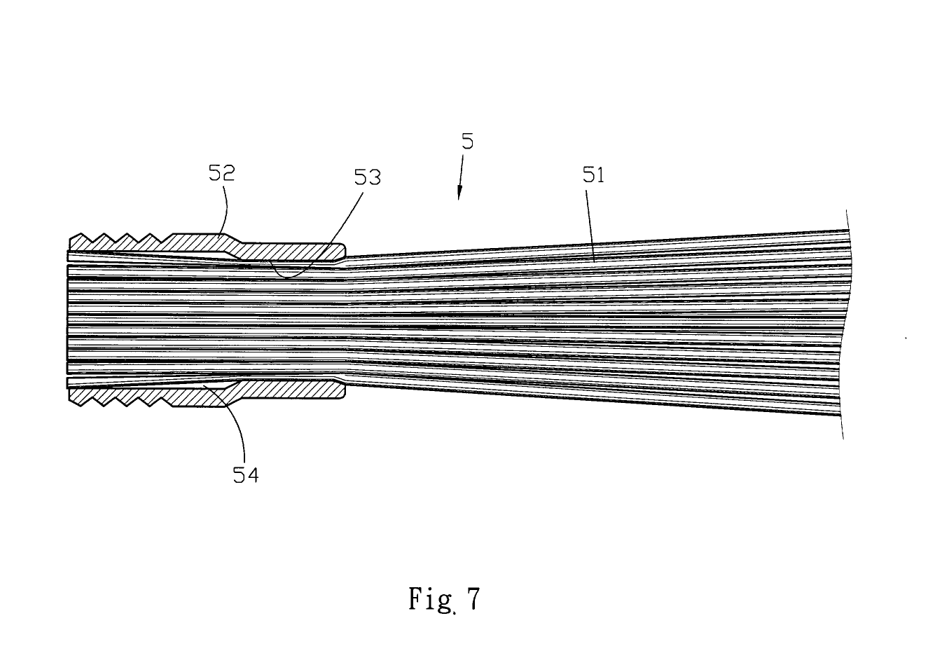

Referring to FIGS. 6 and 7, a patting unit 5 is connected with one end of the sheath body 3. The patting unit 5 is composed of a bundle of patting strips 51 and a binding body 52. The patting strips 51 are slender straight strips. One end of the binding body 52 is compressed by a processing device into a binding section 53. An inner section 54 of the binding body 52 other than the binding section 53 has an original inner diameter. The other end of the binding body 52 is connected with the sheath body 3. The ends of the patting strips 51 are inserted and bound in the binding section 53 into a bundle. After the ends of the patting strips 51 are inserted through the binding section 53, the binding section 53 is inward compressed into smaller diameter to tightly bind the patting strips 51. The ends of the patting strips 51 exceeding the binding section 53 and positioned in the inner section 54 are loosened and diverged. Therefore, the ends of the patting strips 51 will not abut against the binding body 52 to make the patting strips 51 detach from the binding body 52.

The above embodiments are only used to illustrate the present invention, not intended to limit the scope thereof. Many modifications of the above embodiments can be made without departing from the spirit of the present invention.

What is claimed is:

1. Massaging patting bar comprising a massaging roller and a grip body having an insertion member, the insertion member being inserted in the massaging roller, permitting the massaging roller to rotate about the insertion member, the circumference of the roller being formed with multiple massaging protuberances which are spirally arranged about the axis of the roller, whereby when the roller is pressed against a massaged part and rotated back and forth, the massaging protuberances evenly press and massage the massaged part.

2. Massaging patting bar as claimed in claim 1, wherein an end section of the grip body is formed with a thread hole for rotatably connecting with the massaging roller, the other end thereof being adapted to pivotally connect with another massaging roller with different massaging protuberances.

3. Massaging patting bar as claimed in claim 1, wherein two outer ends of the grip body are formed with outer threads for screwing with sheath bodies.

4. Massaging patting bar as claimed in claim 2, wherein two outer ends of the grip body are formed with outer threads for screwing with sheath bodies.

5. Massaging patting bar as claimed in claim 3, wherein one end of the sheath body is formed with inner thread corresponding to the outer thread of the grip body, the other end of the sheath body being a close end or an open end formed with inner thread.

6. Massaging patting bar as claimed in claim 4, wherein one end of the sheath body is formed with inner thread corresponding to the outer thread of the grip body, the other end of the sheath body being a close end or an open end formed with inner thread.

7. Massaging patting bar as claimed in claim 3, wherein the outer end of the sheath body is screwed with a connecting member for connecting with another sheath body so as to elongate the length of the massaging bar.

8. Massaging patting bar as claimed in claim 4, wherein the outer end of the sheath body is screwed with a connecting member for connecting with another sheath body so as to elongate the length of the massaging bar.

9. Massaging patting bar as claimed in claim 7, wherein a bottle body is serially connected with one end of the connecting member, the bottle body containing therein a certain amount of oil or grease, a ball body being inlaid in an opening of the bottle body, a driving unit being disposed in the bottle body and drivable by external force, the driving unit serving to drive a tray body for pushing the oil or grease to attach to the ball body, whereby when the ball body is rotated, a certain amount of oil or grease attaching to inner side of the ball body is moved out and painted on the surface of a user's skin for relieving the massaged part from uncomfortableness.

10. Massaging patting bar as claimed in claim 8, wherein a bottle body is serially connected with one end of the connecting member, the bottle body containing therein a certain amount of oil or grease, a ball body being inlaid in an opening of the bottle body, a driving unit being disposed in the bottle body and drivable by external force, the driving unit serving to drive a tray body for pushing the oil or grease to attach to the ball body, whereby when the ball body is rotated, a certain amount of oil or grease attaching to inner side of the ball body is moved out and painted on the surface of a user's skin for relieving the massaged part from uncomfortableness.

11. Massaging patting bar as claimed in claim 9, wherein the ball body is magnetically polar.

12. Massaging patting bar as claimed in claim 10, wherein the ball body is magnetically polar.

13. Massaging patting bar as claimed in claim 9, wherein a magnet magnetically attracts an inner bottom end of the ball body, a magnet push member being fixedly connected with inner end of the driving unit between the inner end and the magnet, the magnet push member having a polarity identical to that of the magnet.

14. Massaging patting bar as claimed in claim 10, wherein a magnet magnetically attracts an inner bottom end of the ball body, a magnet push member being fixedly connected with inner end of the driving unit between the inner end and the magnet, the magnet push member having a polarity identical to that of the magnet.

15. Massaging patting bar as claimed in claim 3, wherein a patting unit is connected with one end of the sheath body, the patting unit being composed of a bundle of patting strips and a binding body in which the patting strips are inserted.

16. Massaging patting bar as claimed in claim 4, wherein a patting unit is connected with one end of the sheath body, the patting unit being composed of a bundle of patting strips and a binding body in which the patting strips are inserted.

17. Massaging patting bar as claimed in claim 15, wherein one end of the binding body is compressed into a binding section, an inner section of the binding body other than the binding section having an original inner diameter, the patting strips being inserted through the binding section into the binding body, the ends of the patting strips exceeding the binding section and positioned in the inner section being loosened and diverged.

18. Massaging patting bar as claimed in claim 16, wherein one end of the binding body is compressed into a binding section, an inner section of the binding body other than the binding section having an original inner diameter, the patting strips being inserted through the binding section into the binding body, the ends of the patting strips exceeding the binding section and positioned in the inner section being loosened and diverged.
